(19) United States
(12) Patent Application Publication
(10) Pub. No.: US 2008/0163197 A1
(43) Pub. Date: Jul. 3, 2008

(54) MULTI-PRODUCT INSTALLATION TOOL DATABASE ARCHITECTURE

(75) Inventor: Siddhartha Ashok RAO, Sandhausen (DE)

Correspondence Address: KENYON & KENYON LLP, 1500 K STREET N.W., WASHINGTON, DC, 20005, US

(73) Assignee: SAP AG, Walldorf (DE)

(21) Appl. No.: 11/618,789

(22) Filed: Dec. 30, 2006

(51) Int. Cl. G06F 9/445

(52) U.S. Cl. 717/177; 717/174

(57) ABSTRACT

A system and method for providing a database for distributing installation software. The database contains data separated into a user interface layer and an installation layer. The database has a hierarchical status and is associated with a location. Additional databases having their own respective data may be involved. An additional database will be identifiable by a hierarchical status. The hierarchical status of the database is superior to the hierarchical status of the additional database, so that the database is read before the additional database and the database indexes the additional database.

### BACKGROUND

A business system may include a variety of software applications that can be installed on user workstations to allow users to perform operations within the business system. Each software application generally includes an installation application, which when run on a workstation configures the software application on the workstation. Since a business system may include a large number of software applications, many such installations may be required to property configure a workstation before it can be used in the business system. When a previously-installed software application is to be replaced by an updated version of the application, the previous version often must be removed from the workstation prior to installation of the new version. Software applications are installed on workstations one at a time, each having its own installation instructions.

### BRIEF DESCRIPTION OF THE DRAWINGS

FIG. 1 shows an exemplary database architecture according to an embodiment of the present invention.

FIG. 2 shows another exemplary database architecture according to an embodiment of the present invention.

FIG. 3 shows another exemplary database architecture according to an embodiment of the present invention.

FIG. 4 shows a flowchart according to an embodiment of the present invention.

### DETAILED DESCRIPTION

The present invention provides a system and method for an architecture setup for supporting multiple software applications on one or more distribution servers. The present invention also provides a system and method for supporting distribution of multiple software applications to workstations, and effecting essentially simultaneous installation, un-installation, updating, and the like, of those multiple software applications. Such simultaneous installation means that with one action, an administrator or other may effect installation, un-installation, updating, and/or the like, of multiple software applications. A software application may be a software product in its entirety, or part of a software product, i.e., a component.

A software product may be comprised of multiple components. A component, or installation component, may include file(s), registry keys, scripts, etc. installation of a component effects an installation of everything included in that product component. Likewise, uninstallation of a component effects a deinstallation of everything included in that product component.

Activities involving application states such as installation, un-installation, updating, and the like, of software applications are stored in an installation database.

The present system and method provide for a high-performance database format for, for example, a front end software installer. The front end software installer may serve as both the distribution and installation tool of all front end products for a company. Embodiments provide that the database format, or architecture, is flexible and scalable so that both available and future front end products may be added, configured, distributed, and/or installed on workstations or other media. The present system and method may provide for a database architecture that supports an installation engine or server, and via the database architecture, the engine will be able to install, uninstall, administer, patch, etc. multiple products in a single action.

The software installer may be located on a server, a computing device and/or a computer readable medium (e.g., DVD, CDROM, Flash Memory, etc.). The software installer may be at a remote location and connectable via a network.

Embodiments of the present invention may support essentially simultaneous installation of multiple products. Embodiments of the present invention may support administration of the multiple products. Embodiments of the present invention may support features involving the handling of one or more products in a single action. Such features may include assembling and distributing preconfigured packages of products. And, such features may include customizing the products of the preconfigured packages. Embodiments of the present invention may allow an administrator of a distribution server to create specific packages involving multiple products for the essentially simultaneous installation of multiple products on a destination medium, e.g., a workstation. Embodiments of the present invention may support the creation of tools which create the one or more product installation distribution(s). Embodiments of the present invention may support a user interface tree dynamically. Embodiments of the present invention may allow handling of custom dialogs via a custom user interface with a user or administrator or device per product.

In embodiments of the present invention, a software package may include the product and its installation database(s). Likewise, a software package may include multiple products and their respective installation database(s). In order to distribute and install, for example, multiple products on a destination medium or media, embodiments of the present invention provide a split database. The database may be split on various levels such as hierarchical, location, and/or content levels. Further, each product and its parts may be identifiable by a unique identifier, or GUID (globally unique identifier), which is maintained by the database(s).

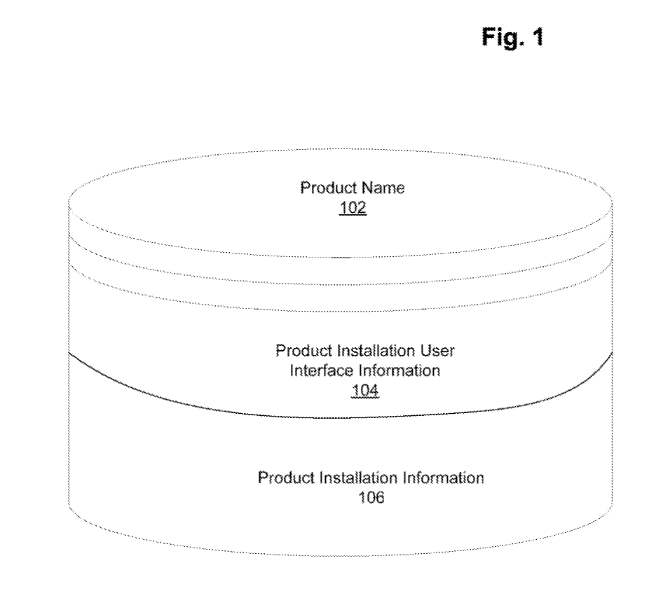

FIG. 1 shows an exemplary embodiment of a split product database. A database may be split into essentially two partitions. A first partition 104 contains the user interface information. A second partition 106 contains the product installation data. The partitioning of the user interface information and the product installation data may be identifiable via the <Product> element declaration or name 102.

In embodiments of the present invention, user interface information may include a product listing, a product component/sub-component listing, information pertaining to the display of the product(s) available for installation, and information pertaining to product and/or product component selection, auto selection, deselection, and auto deselection in the user interface. For example, the user interface information may include an indication for auto-selection of a products' component(s)/sub-component(s) if a parent product is selected and/or auto-selection of any product component(s)/sub-component(s) on which a selected product component(s)/subcomponent(s) is dependent. As discussed above, a product may be an entire product or part thereof. The user interface information may maintain information pertaining to the entire product and its individual product parts. The user interface also may include package creation and/or package display information.

In embodiments of the present invention, product installation information may include information regarding the product file(s) such as its path, version, etc. The product installation information may include the registration information for the product. The product installation information may include the data for the product installer to configure the front end product installation, and possible other information desired for the installer.

In embodiments of the present invention, the user interface information partition is separated from the product installation information in a database by a declaration tag or product tag.

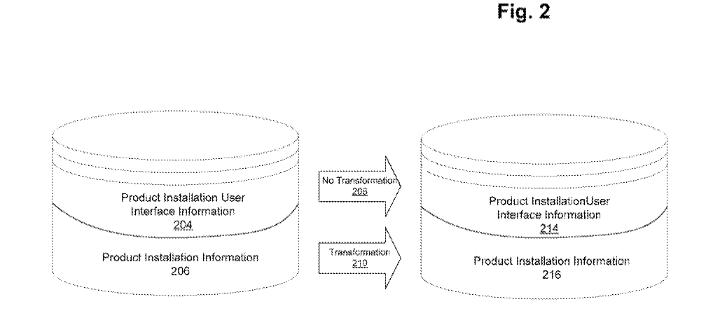

FIG. 2 shows an exemplary embodiment of a split product database on an installation server and a split product database on a destination location. The destination location may be, for example, a workstation or other storage media. At least one database is located on the installation server and may include a <Product> element declaration. The installation server database(s) is split into two partitions. A first partition 204 contains user interface information. A second partition 206 contains product installation data. During installation of one or more products from the installation server to a destination location, for example, to a workstation, certain events occur. The user interface information partition 204 is moved without changes, i.e., no transformation of the data, to the workstation database. The user interface information partition 214 on the workstation database later will be used to display the list of products available and those installed. This non-transformation of the user interface information may support product browsing, allowing the workstation user to see the products to be installed, and provide the user with the ability to reconfigure the installation (e.g., add/remove products). This direct copy of the user interface information from the server database to the workstation database allows the workstation user to see an identical user interface tree of products and parts thereof as seen by the user at installation. The workstation engine database may distinguish the products and parts thereof on the tree list as installed and not installed by looking up the presence of the product and/or parts thereof located by their declaration, or for example, an .xml <contains> tag.

The product installation data partition 206 is moved with changes, i.e., a transformation of the data, to the corresponding product database on the workstation. The product installation data partition 216 on the workstation is undergoes a transformation into a format suited for product administration on the workstation. For example, variables used in indicating destination directories need to be transformed so as to be functional to the workstation tools. The installation engine or server may execute this transformation of data. The newly installed database may include a <Product> element declaration or name.

Embodiments of the present invention may allow for, as discussed above, the database(s) to be split on hierarchical, location, and content levels. The hierarchical level may indicate that the database is a installation server, or engine, database or a product database. The installation server database contains installation software relevant information and installation software data displayed on the user interface. Installation software relevant information may include the files of the installer, versions, etc. The installation server database also identifies and locates associated product database(s). That is, the installation server database indexes and maintains the index of the other databases associated with the product, i.e., the product database(s). Accordingly, the installation server database contains a hierarchical level necessitating that it is read first, i.e., before tire associated product database(s) are read. The product database(s) are then read. The product database(s) may not have any indication of different hierarchical status between them and thus, may be read in the order indexed by the installation database. The product database(s) may contain front end product information including, for example, product files, respective product file paths, registry keys, etc. The product database(s) may also contain product information that is displayed on the user interface. And, the product database may include information on preconfigured (for example, by an administrator or dynamically configured based on preexisting instructions) software package information. The location level may indicate whether the database is located on the server or on the workstation. The location level indicates the address of the database. This location level indication may be included in a product tag or label of the database. The content level may indicate whether the content is user interface information, i.e., product display information, or product installation information. For example, in FIG. 2, the product database on the workstation includes a split of the content levels, i.e., a user interface information partition 214 and a product installation data partition 216. The same product database also includes a location address and product label, or declaration, 212 indicating that the database is located on the workstation, and not on the server installer.

In embodiments of the present invention, database information may be stored, for example, as an XML file or other appropriate storage mechanism.

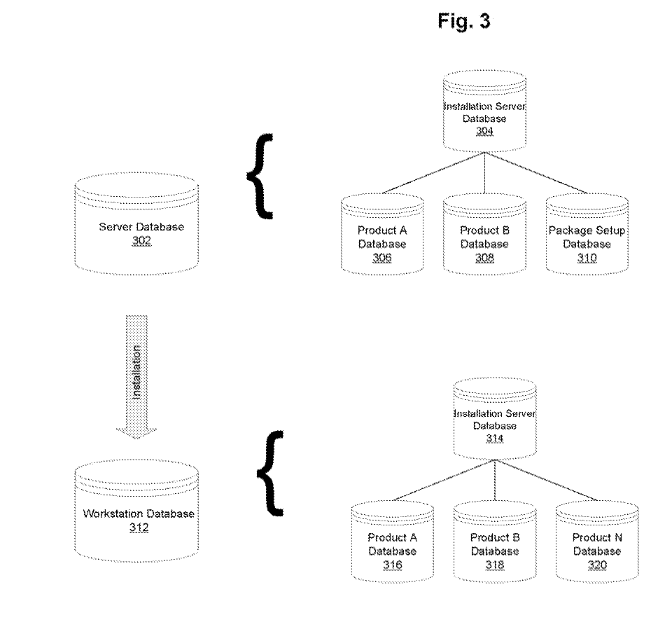

FIG. 3 shows an exemplary embodiment 300 of the transformation between, for example, a server location and a destination location, and the database hierarchies. The server database 302 has an installation server database 304 which is hierarchically superior to its associated product databases 306, 308, 310. The installation server database 304 identifies and indexes the product databases. A product database 306 may include installation information relevant to a first product component. Another product database 308 may include installation information relevant to a second product component. Another product database 310 may include installation information relevant to a package setup of the first and second product components.

The server database using deployment tools may be used to install software, e.g., the package of multiple products or parts thereof, on a workstation or other destination location. That is, information is transferred from the server database to the workstation database. The resulting workstation database 312 may contain a corresponding installation server database 314 which identifies and indexes a first product database 316, a second product database 318, and possible other product database(s) 320. Those databases include the location address of the workstation. In the course of the installation from the distribution server to the workstation, the installer engine may be required to convert information contained in the server database to a format suitable to the workstation tools before depositing the database on the workstation. Such conversions may include an interpretation of path names (e.g., change server location path name to a workstation location path name), variables (e.g., a variable tag to specify the relative path or other parameters of the installation), usage counts (e.g., an indication that a product or part thereof is required by other product(s) or part(s) thereof if installed), etc.

In embodiments of the present invention, an installation server database may indicate its equivalent workstation database. This may allow an administrator to keep track of which products or parts thereof are loaded onto which workstations. Further, this may allow for future updates, removals, and/or patches initiated by a distribution server.

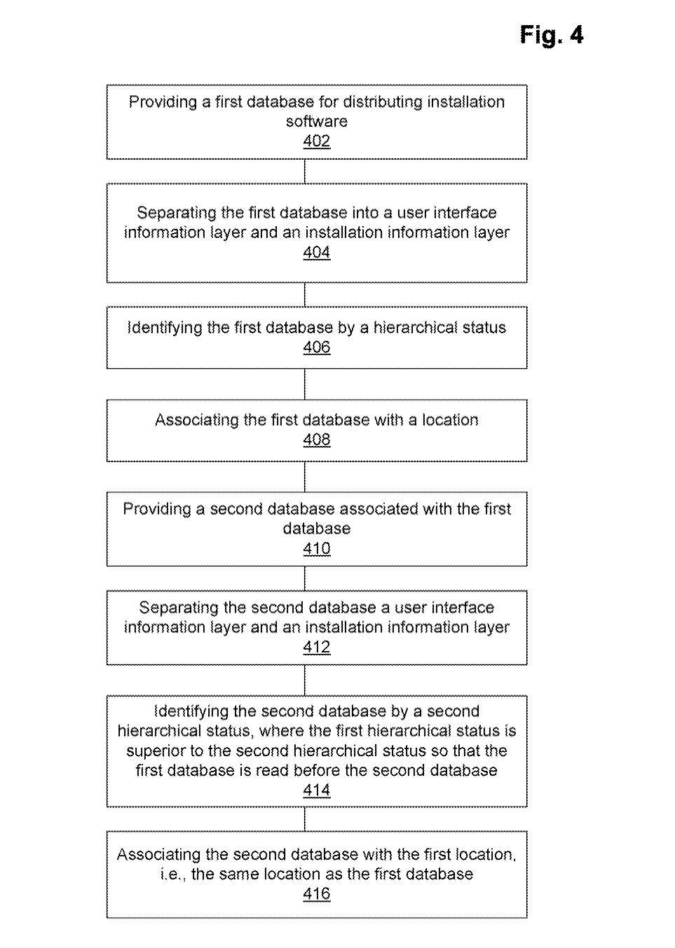

FIG. 4 shows a flowchart illustrating an embodiment of the present invention. A first database for distributing installation software is provided 402. The first database is separated into a user interface information layer and an installation information layer 404. Software product installation data is represented via a product element declaration tag in the installation information layer and via a content of the product element declaration tag in the user interface information layer. The first database is identified by a hierarchical status 406. The first database is associated with a location 408. A second database is provided 410 and is separated into a user interface information layer and an installation information layer 412. The second database is identifiable by a second hierarchical status, where the first hierarchical status is superior to the second hierarchical status so that the first database is read before the second database 414. The second database is associated with the first location, i.e., the same location as the first database 416. Additional databases may be associated with the first database, and be hierarchically subordinate to the first database, and hierarchically the same as the second database.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A system, comprising:
a first database for distributing installation software; and
at least one second database for distributing installation software, each of the at least one second database containing data separated into a respective user interface layer and a respective installation information layer,
wherein the first database indexes the at least one second database.

2. The system of claim 1, wherein the first database is identifiable by a first hierarchical status and the at least one second database is identifiable by a second hierarchical status, the first hierarchical status is superior to the second hierarchical status so that the first database is read before the at least one second database.

3. The system of claim 2, wherein the first database and at least one second database are associated with a first location, the first location identifying the address of the first database, and the first database identifying the address of the at least one second database.

4. The system of claim 3, wherein the at least one second database is a plurality of databases, wherein each database of the plurality of databases has a respective hierarchical status, each respective hierarchical status being equal in hierarchy to each other and less superior to the first hierarchical status associated with the first database.

5. The system of claim 1, wherein the first database contains data separated into a first user interface layer and a first installation information layer.

6. The system of claim 1, further comprising:
a third database for distributing installation software; and
at least one fourth database for distributing installation software, each of the at least one fourth database containing data separated into a respective user interface layer and a respective installation information layer,
wherein the third database indexes the at least one fourth database.

7. The system of claim 6, wherein the third database is identifiable by a third hierarchical status and the at least one fourth database is identifiable by a fourth hierarchical status, the third hierarchical status is superior to the fourth hierarchical status so that the third database is read before the at least one fourth database.

8. The system of claim 7, wherein the third database and at least one fourth database are associated with a second location, the second location identifying the address of the third database, and the third database identifying the address of the at least one fourth database.

9. The system of claim 6, wherein the third database contains data separated into a third user interface layer and a third installation information layer

10. The system of claim 8, wherein the first location is a server, and the second location is a workstation.

11. A method for creating an installation database system, comprising:
providing a first database for distributing installation software; and
providing at least one second database for distributing installation software;
indexing the at least one second database by the first database,
wherein each of the at least one second database contains software installation data separated into a respective user interface layer and a respective installation information layer.

12. The method of claim 11, further comprising:
reading the first database, the first database being identifiable by a first hierarchical status; and
reading the at least one second database, the at least one second database being identifiable by a second hierarchical status,
wherein the first hierarchical status is superior to the second hierarchical status so that the first database is read before the at least one second database.

13. The method of claim 12, further comprising:
associating the first database and the at least one second database with a first location,
wherein the first location identifies the address of the first database, and the first database identifies the address of the at least one second database.

14. The method of claim 11, further comprising:
providing a third database for distributing installation software;
providing at least one fourth database for distributing installation software;
indexing the at least one fourth database by the third database;
associating the first database and the at least one second database with a first location;
associating the third database and the at least one fourth database with a second location,
wherein the first location identifies the address of the first database, and the first database identifies the address of the at least one second database; the second location identifies the address of the third database, and the third database identifies the address of the at least one fourth database, and each of the at least one fourth database contains software installation data separated into a respective user interface layer and a respective installation information layer.

15. The method of claim 14, further comprising:
reading the third database, the third database being identifiable by a third hierarchical status; and
reading the at least one fourth database, the at least one fourth database being identifiable by a fourth hierarchical status,
wherein the third hierarchical status is superior to the fourth hierarchical status so that the third database is read before the at least one fourth database.

16. The system of claim 14, wherein the third database contains data separated into a respective user interface layer and a respective installation information layer.

17. The system of claim 11, wherein the first location is one of a server, a computing device, and a computer readable medium, and the second location is one of a workstation, a computing device, and a computer readable medium.

18. An installation database system comprising:
a first database for distributing installation software, wherein the first database contains data separated into a first user interface layer and a first installation information layer, the first database being identifiable by a first hierarchical status, and the first database being associated with a first location;
at least one second database containing other data separated into a respective second user interface layer and a respective second installation information layer, the at least one second database identifiable by a respective second hierarchical status, wherein the first hierarchical status is superior to the respective second hierarchical status so that the first database is read before the respective second database, the at least one second database being associated with the first location;
a third database for distributing installation software, wherein the third database contains data separated into a third user interface layer and a third installation information layer, the third database being identifiable by a third hierarchical status, and the third database being associated with a second location;
at least one fourth database containing other data separated into a respective fourth user interface layer and a respective fourth installation information layer, the at least one fourth database identifiable by a respective fourth hierarchical status, wherein the third hierarchical status is superior to the respective fourth hierarchical status so that the third database is read before the respective fourth database, the at least one fourth database being associated with the second location;
wherein the first hierarchical status is superior to the respective second hierarchical status so that the first database associated with the first hierarchical status is read before the at least one second database associated with the respective second hierarchical status, and the first database indexes the at least one second database, and the third hierarchical status is superior to the respective fourth hierarchical status so that the third database associated with the third hierarchical status is read before the at least one fourth database associated with the respective fourth hierarchical status, and the third database indexes the at least one fourth database.

19. The system of claim 18, wherein the first location identifies the address of the first database, and the first database identifies the address of the at least one second database, and the second location identifies the address of the third database, and the third database identifies the address of the at least one fourth database.

20. The system of claim 19, wherein the first location and second location are one of located in the same software system; located in separate software systems; located on the same computing device; located on different computing devices.
